(19) United States
(12) Patent Application Publication
(10) Pub. No.: US 2007/0159556 A1
(43) Pub. Date: Jul. 12, 2007

(54) Luminance transient improvemet using video encoding metric for digital video processing

(75) Inventors: Yibin Yang, Pine Brook, NJ (US); Lilla Boroczky, Mount Kisco, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/599,064

(22) PCT Filed: Mar. 25, 2004
(86) PCT No.: PCT/IB05/50979

§ 371 Date: Sep. 19, 2006

Related U.S. Application Data
(60) Provisional application No. 60/556,166, filed on Mar. 25, 2004.

(51) Int. Cl. H04N 5/21

(52) U.S. Cl. 348/626

(57) ABSTRACT

A method of improving luminance transition includes decoding a coded video bitstream around a transition from a first luminance level to a second luminance level; and providing luminance transition enhancement based on a metric indicative of video bitstream. Additionally, an apparatus that improves a luminance transition includes a video decoder and a module that determines a metric indicative of the degree of video coding artifacts in a signal. The apparatus also includes a video processing module that includes a luminance transient enhancement module. The luminance enhancement module provides transition based on at least a value of the metric at the transition.

The present application claims priority under 35 U.S.C. § 120 and 35 USC § 365(c) to International Patent Application serial number IB2003/0057 filed on Dec. 4, 2003 and entitled “A Unified Metric For Digital Video Processing (UMDVP)” to Yang, et al; to U.S. patent application Ser. No. 10/023,131 entitled “Natural Luminance Transient Enhancement” to Bellers; and to U.S. Provisional Application serial number (Philips Reference No. US 040135) entitled “Ringing Artifact Reduction for Compressed Video Applications” to Boroczky, et al. and filed Feb. 27, 2004. These applications are assigned to the present assignee, and the disclosures of these applications are specifically incorporated herein by reference.

Moving Picture Expert Group (MPEG) video compression technology facilitates many current and emerging video products (e.g., DVD players, high definition television decoders, and video conferencing) by requiring less storage and less bandwidth. The video compression comes at the expense of a reduction in picture quality due to the introduction of artifacts. For example, it is well known that such compression technology (e.g., MPEG-1, MPEG-2, MPEG-4, H.26x, etc.) can cause the introduction of coding artifacts that decrease picture quality of the decoded video.

As is well-known, video compression technology may be in a variety of formats, such as those listed above. Moreover, encoded video signals may be received by a variety of applications to include liquid crystal on silicon (LCOS) and other LCD devices. LCOS devices have the capability of providing relatively high resolution video images. However, compression artifacts that are not readily discemable in many display technologies may be significant in an LCOS display due to its intrinsic sharpness. Therefore, there exist drawbacks in certain known artifact reduction methods and apparati.

In addition to the need to reduce artifacts, the perceived sharpness of a video signal often requires enhancement. Known improvements in the perceived sharpness of a displayed video image produced from a video signal are typically accomplished with edge transient sharpness enhancement methods that employ an enhancement signal, which is added to the video signal to steepen edge transients contained therein. Utilizing such an enhancement signal steepens the rise in a transition from a dark image region to a light image region, or alternatively, steepens the fall in a transition from a light image region to a dark image region.

Some edge transient sharpness enhancement methods employ linear techniques which enhance frequencies that are already within the video image by using a linear high frequency boosting filter. Other prior art edge transient sharpness enhancement methods employ non-linear techniques that attempt to steepen the edge transients.

While known methods of sharpness enhancement have provided some improvement in the sharpness of a transition, there are certain drawbacks and shortcomings that remain. For example, if at a transition there are a significant number of coding artifacts, sharpness enhancement will likely enhance the artifacts as well, creating a reduction in the image quality.

In accordance with an example embodiment, a method of improving luminance transition includes decoding a coded video bitstream around a transition from a first luminance level to a second luminance level; and providing luminance transition enhancement based on a metric indicative of video artifacts present in the decoded video bitstream.

In accordance with another example embodiment, an apparatus that improves a luminance transition includes a video decoder and a module that determines a metric indicative of the degree of video coding artifacts in a signal. The apparatus also includes a video processing module that includes a luminance transient enhancement module. The luminance enhancement module provides transition based on at least a value of the metric at the transition.

The invention is best understood from the following detailed description when read with the accompanying drawing figures.

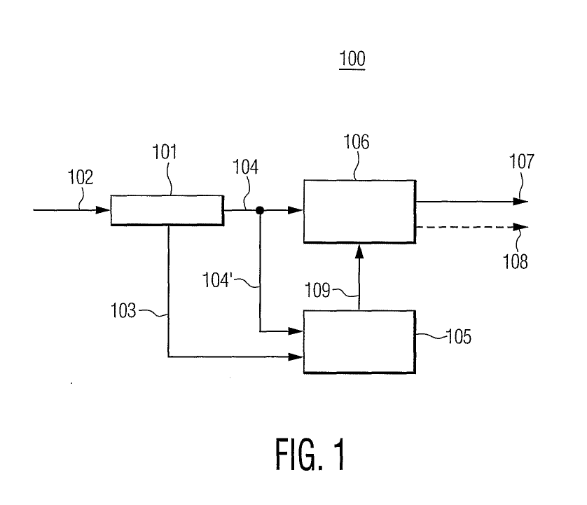

FIG. 1 is a schematic block diagram of an apparatus for improving transient edge sharpness using a metric indicative of the video artifacts about at an edge in accordance with an example embodiment.

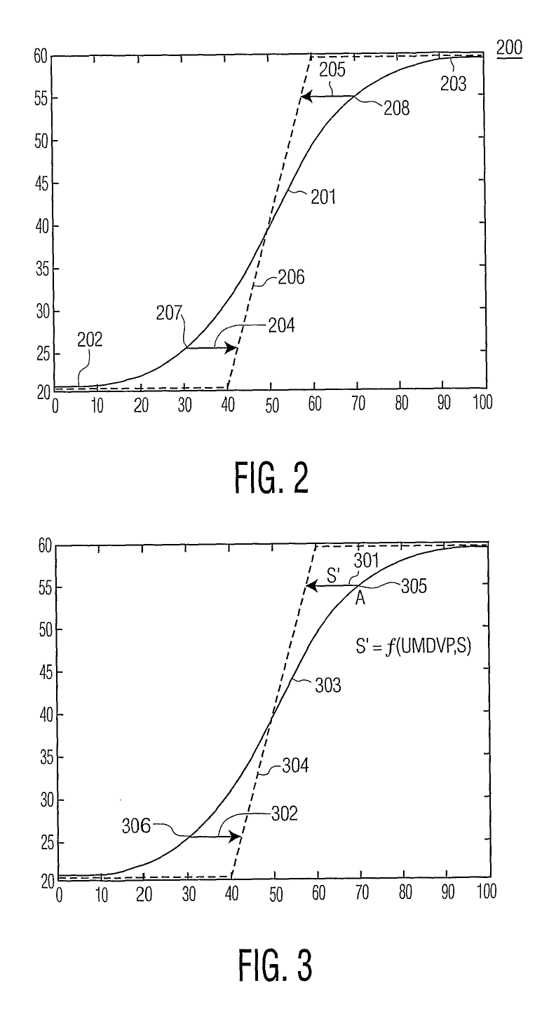

FIG. 2 is a graphical representation of the intensity value (relative scale) versus pixel position about a transition from dark to light.

FIG. 3 is a graphical representation of the intensity value (relative scale) versus pixel position about a transition from dark to light incorporating a method of an example embodiment.

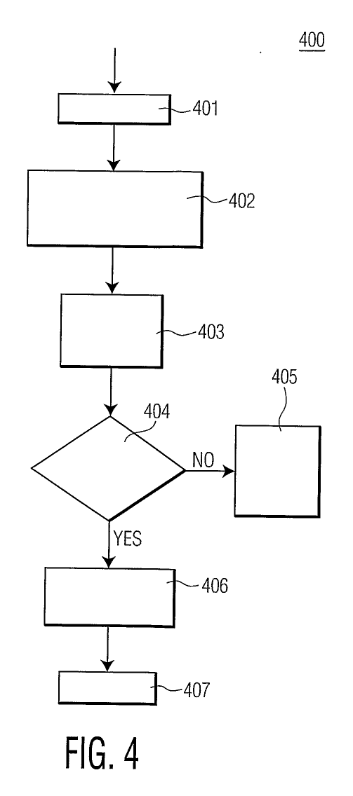

FIG. 4 is flowchart of a method of providing video enhancement in accordance with an example embodiment.

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known apparati and methods may be omitted so as to not obscure the description of the present invention. Such methods and apparati and methods are clearly within the contemplation of the inventors in carrying out the example embodiments. Wherever possible, like numerals refer to like features throughout.

FIG. 1 is a schematic block diagram of an apparatus 100 for improving luminance transitions of compressed digital video signals in accordance with an example embodiment. It is noted that, unless otherwise described, the modules/devices of the example embodiments of FIG. 1 include hardware, or software or both that perform functions described herein. This hardware, or software, or both are within the purview of one of ordinary skill in the art, and thus are not described in detail so as to not obscure the description of the example embodiments.

A decoder 101 module decodes an input video signal 102, by one or more of a variety of known techniques. A decoded video signal 104 is output to a video processing module 106, while a portion is tapped as signal 104′ and input to a metric calculation device 105 for further processing.

Coding information 103 is also output by the decoder 101 and is input into the metric calculation device 105. As described in application serial number (704245) entitled “Ringing Artifact Reduction for Compressed Video Applications”, and IB2003/0057 (referenced previously) this coding information 103 is used by the metric calculation device 105 to promulgate artifact reduction and to update metric information of the processed video signal. Furthermore, as will become clearer as the present description continues this metric is also used to determine the degree, if at all, that a luminance transient improvement (LTI) technique is applied to luminance transitions of the decoded video signal 104.

As such, after certain methods of example embodiments are applied to the coding information, the metric 109 is input to the video processing module 106. This video processing module 106 then applies certain methods of example embodiments to adjust the improvement on luminance transients, as well as other video processing functions, to the decoded video 104. Other illustrative functions of the video processing module include, but are not limited to noise reduction and artifact reduction. It is noted that other video processing effected in the video processing module may be one or more of those described in the co-pending applications, as well as other methods within the purview of one of ordinary skill in the art having had the benefit of the present disclosure.

The video processing module 106 then outputs a post-processed video signal 107, which provides an improved image from the perspective of image quality. The module 106 optionally outputs an updated metric for the signal 108, fostering the better image quality. It is noted that the various devices of the apparatus 100 may be electronic devices readily apparent to one having ordinary skill in the art, and are thus not described in further detail. Furthermore, it is noted that the example embodiments described herein primarily focus on LTI of the input compressed digital video signal 102. However, it is noted that other functions may be applied. For example, artifact reduction and video enhancement methods and apparati may be carried out as described in co-pending applications (serial number IB2003/0055 and reference number 70425) referenced previously. As such, the methods and apparati of the commonly-owned applications are specifically incorporated herein by reference.

In the example embodiments described herein, the compressed digital video signals are in the MPEG-2 format, and the metric is the UMDVP metric described in the co-pending application IB/20030057 referenced previously, as well as discussed in greater detail below. As such, the decoder module 101 is illustratively an MPEG-2 decoder, the signal input to the decoder 101 is an MPEG-2 signal, and the output from the decoder and from the artifact reduction device are in MPEG-2 format. Moreover, the coding information 103 is illustratively MPEG-2 coding information, and the output (109) from the metric calculation is UMDVP data. Furthermore, in the present application, the metric calculation device 105 may be referred to as a UMDVP calculation device 105; the decoder 101 may be referred to as the MPEG-2 decoder. Finally, the LTI techniques referenced herein may be one or more of those described in commonly assigned U.S. Pat. Nos. 6,600,517; 6,094,205; 6,657,677; 5,606,276; and U.S. Patent Application Publications 2003/0112373; 2003/01977212. The disclosures of these patents and publications are specifically incorporated herein by reference.

However, it is noted that the referenced formats, metrics and LTI methods are merely illustrative of the example embodiments. To wit, other formats and metrics, to include other known digital video compression formats and metrics, as well as the progeny of known video compression formats, metrics and LTI methods may be used in keeping with the example embodiments described herein.

FIG. 2 is a graphical representation 200 of one illustrative known method of LTI. It is noted that this method does not incorporate the use of a metric to control the video enhancement as is effected using example embodiments. Rather it is shown to provide a brief understanding of a known LTI technique.

The LTI method shown in FIG. 2 is a non-linear approach that modifies the gradient of the edges between a region of lower luminance (or intensity) light and a region of higher luminance light of an image. To wit, the curve 201 shows the actual luminance versus pixel position in one dimension. As can be appreciated, the transition of curve 201 from low luminance 202 to high luminance 203 is rather gradual, thus reducing the perceived sharpness of the edge. Accordingly, it would be beneficial to increase the rate of transition to increase the perceived sharpness of the edge/transition. The known LTI method selectively modifies the gradient at points on the curve 201 to provide a curve 206. For example, at a point 207 the gradient is changed and the curve shifted by an amount 204, and at a point 208, the gradient is changed and the curve shifted by an amount 205. This process is iteratively effected along the curve 201 to realize the curve 206.

While the LTI of FIG. 2 has shown improvement in the edges of video signals, it requires further improvement according to the example embodiments. One way to provide a better quality output video 107 is described presently in conjunction with FIG. 3.

FIG. 3 is a graphical representation 300 of the LTI method of an example embodiment. In the present embodiment, the metric calculation information from the metric calculation module 105 is input to the video processing module 106, so that the LTI may be modified to incorporate the metric data.

For example, in an example embodiment, the metric is the UMDVP data for a MPEG-2 video bitstream. These UMDVP values include information of the degree of coding artifacts in the signal. For example, a UMDVP value of 1 at a block, pixel or subpixel indicates that there are few artifacts in the signal, whereas a UMDVP value of 0 may indicate the presence of significant artifacts. As such, if there are many artifacts, video enhancement should not be done unless the artifacts are removed, if at all.

As such, LTI methods of example embodiment include a dependence on the metric value. In one example embodiment, the LTI may be expressed as:
S′=f(UMDVP,S) (1)

where S is the shift at a particular point on the edge (e.g., curve 303) as determined by the LTI method, and S′ is the shift at the point on the edge according to an example embodiment.

For example, the shifts S from application of the LTI method of FIG. 2 are shown at 205 and 207 at two points along the edge. Contrastingly, in the example embodiment of FIG. 3, the shifts are of an amount S′, which is tempered by the UMDVP value at the particular point. To this end, in an example embodiment an unprocessed gradual luminance transition curve 303 is transitioned to a sharper curve 304. However, the shift S′ 301 and 302 at illustrative points 305 and 306 along the curve 303 are dependent on the UMDVP value at the respective points on the curve 303. As such, incorporating the UMDVP valve may result in less of a ‘shift’ if the UMDVP value is relatively low and a complete shift if the UMDVP value is relatively high. It is noted that the shift S′ is a function of the UMDVP value a particular point in the curve 303 and the shift S from the LTI. Thus, the magnitude of the shift 301 and the magnitude of the shift 302 are not necessarily equal. Of course this applies to all values of S′ along the curve 303.

As can be readily appreciated, through the dependence on the UMDVP value at each point, the application of the LTI may be reduced in areas of an image that are impaired by coding artifacts; and if the decoded video were processed using the unabated LTI method, would be further impaired in quality rather than improved.

In accordance with another example embodiment, the shift S′ is given by:
S=UMDVP×S (2)
where the UMDVP value is for a particular location on the edge of the transition and S is the shift from the LTI method chosen As can be readily appreciated, the shift S′ is directly proportional to the UMDVP values. The UMDVP values range from −1 to +1, and the smaller the UMDVP value is more significant are the artifacts. In practice, it is noted that only positive UMDVP values may be used in the present example embodiment. If the value of the UMDVP is equal to or less than zero, no video enhancement is effected.

The method incorporating eqn. (2) is merely illustrative of an example embodiment. Clearly, other relationships for determining the shift S′ based on the UMDVP and the shift S that improve the luminance transition are within the scope of the example embodiments. For example, in accordance with another example embodiment, the shift S′ is given by:

$${S}^{′} = \{ \begin{matrix}0 & if UMDVP < 0 \\ S \times UMDVP & if 0 \leq UMDVP < T 1 \\ \{ T 1 + S 1 * ( UMDVP - T 1 ) \} \times S & T 1 \leq UMDVP\end{matrix} \qquad ( 3 )$$

where T1 is a threshold (e.g., 0.3) and S1 is another control parameter (e.g., 5.0).

It is noted that after performing the UMDVP-controlled artifact reduction, the UMDVP values are usefully may be updated. Thereafter, the value of S′ is calculated using the new UMDVP values. As such, video enhancement to include luminance transition enhancement of example embodiments, may be effected after the artifact reduction is effected. Beneficially, this prevents enhancing video signals with an unacceptable level of artifacts, and provides for the enhancement of artifact-reduced video. Ultimately, the post-processed video quality is improved by this example embodiment.

FIG. 4 shows a flowchart of an illustrative method 400 of selectively applying an LTI method of an example embodiment. It is noted that the method may be used in conjunction with the apparatus 100 of the embodiment of FIG. 1.

At step 401, the coded video bitstream is decoded into the decoded video and the coding information. At step 402, the decoded video is provided to a video processing module, and optionally to a metric calculation module. The coding information is provided to the metric calculation device. In an example embodiment, the coded video is MPEG-2 and the metric is the UMDVP.

In step 403, the metric calculation value is determined. In step 404, the metric value is compared to a threshold, and if this metric is above a threshold, the method continues to step 406. If the metric is less than the threshold, the method terminates at step 405. In an example embodiment, the metric is the UMDVP value, and the threshold is zero. Of course, this is merely illustrative, and other metrics and thresholds may be used. In some cases the threshold may require the metric value to be equal to or less than the threshold, while in others the threshold may require the metric to be equal to or above the threshold.

As referenced above, in an example embodiment, if the metric value is greater than the zero, the shift is calculated in step 406 pursuant to the relationship of equation (2). It is noted that the functional dependence set forth in equation (1) provides a number of specific relationships to realize a modified LTI method. Generally, the threshold of a UMDVP value greater than zero applies.

Finally, if the metric value does not meet the criteria set in step 404, at step 405, the no video enhancement (e.g. LTI) is carried out and the existing transition edge is provided by the output processed video. Alternatively, the video enhancement (e.g. LTI) would be effected after completing artifact reduction.

In view of this disclosure it is noted that the various methods and devices described herein can be implemented in either software or hardware or a combination of the two to achieve a desired performance level. Further, the various methods and parameters are included by way of example only and not in any limiting sense. Therefore, the embodiments described are illustrative and are useful in reducing ringing artifacts, particularly around strong edges, as well as to provide an updated metric value, and are not intended to be limitive to the example embodiments. In view of this disclosure, those skilled in the art can implement the various example devices and methods in determining their own processing of the decoded digital video, while remaining within the scope of the appended claims.

1. A method of improving luminance transition in a video signal, the method comprising:
decoding a coded video bitstream (102) around a transition from a first luminance level to a second luminance level; and
providing a luminance transition enhancement based on a metric (109) indicative of the degree of video artifacts present in the decoded video bitstream (104).

2. A method as recited in claim 1, further comprising, after the decoding, calculating the metric from coding information from the coded video bitstream.

3. A method as recited in claim 1, wherein the metric is a unified metric for digital video processing (UMDVP).

4. A method as recited in claim 3, wherein the video transition enhancement is based on a luminance transient improvement (LTI) value.

5. A method as recited in claim 4, wherein an enhancement is effected, if at all, when the UMDVP value is greater than zero.

6. A method as recited in claim 5, wherein if the UMDVP value is less than a predetermined value, video enhancement is effected only after performing artifact reduction.

7. A method as recited in claim 4, wherein the UMDVP value is greater than a predetermined value, and a shift, S′, is applied at a particular location on a luminance transition curve of a video signal.

8. A method as recited in claim 7, wherein a plurality of UMDVP values are determined for a plurality of locations on a luminance transition curve; and a plurality of respective shifts, S′, are calculated for the respective spots.

9. A method as recited in claim 7, wherein:
S=f(UMDVP,S)
where S is the shift from the LTI.

10. A method as recited in claim 8, wherein the locations are one or more of: a block, a subpixel or a pixel.

11. An apparatus that improves luminance transitions, comprising:
a video decoder;
a metric calculation module that determines a metric indicative of the degree of video artifacts in a signal; and
a video processing module that includes a luminance transient enhancement module,
wherein the luminance transient enhancement module provides a video transition based on at least a value of the metric at a location.

12. An apparatus as recited in claim 11, wherein the metric calculation module receives coding information from the decoder.

13. An apparatus as recited in claim 11, wherein the video processing module also at least includes an artifact reduction module.

14. An apparatus as recited in claim 12, wherein the metric is unified metric for digital video processing (UMDVP).

15. An apparatus as recited in claim 14, wherein the video enhancement module determines a luminance transient improvement (LTI) value for a plurality of locations along a luminance transition curve.

16. An apparatus as recited in claim 15, wherein the metric calculation module determine a UMDVP value for each of the plurality of locations.

17. An apparatus as recited in claim 16, wherein the video enhancement module effects a shift, S′, at a particular location only if a corresponding UMDVP value is greater than a predetermined value.

18. An apparatus as recited in claim 16, wherein the video enhancement module effects a shift, S′, at a particular location only after an artifact reduction module effects artifact reduction.

19. An apparatus as recited in claim 16, wherein the video enhancement module performs no shift at the particular one of the plurality of locations if the UMDVP value is less than a predetermined value.

20. An apparatus as recited in claim 16, wherein the locations are one or more of: a block, a subpixel or a pixel.
